(19) United States
(12) Patent Application Publication
(10) Pub. No.: US 2008/0184034 A1
(43) Pub. Date: Jul. 31, 2008

(54) IMAGE FORMING APPARATUS AND CONTROL METHOD THEREOF

(75) Inventor: Michiaki Konno, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/626,923

(22) Filed: Jan. 25, 2007

(51) Int. Cl. H04L 9/32

(52) U.S. Cl. 713/183

(57) ABSTRACT

An image forming apparatus of the invention includes a radio communication unit that is capable of performing radio communication with an external terminal apparatus and a control unit that controls the radio communication unit. The image forming apparatus controls the radio communication unit to transmit, when a transmission signal from the terminal apparatus is received by the radio communication unit, a signal for requesting a security code to the terminal apparatus and transmit, when the security code from the terminal apparatus is received, individual information including network information of the image forming apparatus to the terminal apparatus. Consequently, the terminal apparatus can receive the network information transmitted from the image forming apparatus and perform setting for network connection using this network information received.

### BACKGROUND OF THE INVENTION

1. Field of the Invention

The present invention relates to an image forming apparatus that makes it possible to perform radio communication with a terminal apparatus and a control method thereof.

2. Description of the Related Art

In general, image forming apparatuses such as an MFP (Multi-Function Peripherals), a copying machine, and a printer have a copy function and a scan function. In some cases, an image forming apparatus and a terminal apparatus are connected via a network, image data created by the terminal apparatus is printed by the image forming apparatus, and image data scanned and read by the image forming apparatus is transmitted to the terminal apparatus. As the terminal apparatus, there are a PC (Personal Computer), a PDA (Personal Digital Assistant), and the like.

In a system connected via a network, when a user uses the terminal apparatus while moving away from office, for example, when the user wishes to move to and work in a business travel destination or another department and perform printing and the like using an image forming apparatus at the moving destination, time and labor are required to connect the terminal apparatus to the image forming apparatus and perform printing because the user does not know various setting contents such as an IP address.

An output system with right-to-use authentication function is described in JP-A-2005-135373. In this example, a user terminal, a printer, and a server are connected via the Internet and the printer receives document data and a user ID from the user terminal and permits use of the printer using the user ID.

However, in this example, the user makes connection to the printer with some method and transmits document data and a user ID. This is on condition that the user has already acquired network information sufficient for accessing the printer.

The present invention provides an image forming apparatus and a control method thereof that simplifies setting in connecting a terminal apparatus to a network.

### BRIEF DESCRIPTION OF THE DRAWINGS

FIG. 1 is a diagram showing a network system that uses an image forming apparatus of the invention;

FIG. 2 is a diagram for explaining a schematic structure of the image forming apparatus of the invention;

FIG. 3 is a block diagram showing a structure of an embodiment of the image forming apparatus of the invention;

FIG. 4 is a block diagram showing a radio communication unit used in the image forming apparatus of the invention;

FIG. 5 is a sequence chart for explaining operations of the image forming apparatus of the invention; and

FIG. 6 is an explanatory diagram showing an example of transmission data in the flowchart in FIG. 5.

### DETAILED DESCRIPTION OF THE INVENTION

Throughout this description, the embodiment and example shown should be considered exemplars, rather than limitations on the apparatus and methods of the present invention.

An embodiment of the invention will be hereinafter explained in detail with reference to the drawings. In the respective figures, identical components are denoted by identical reference numerals and signs.

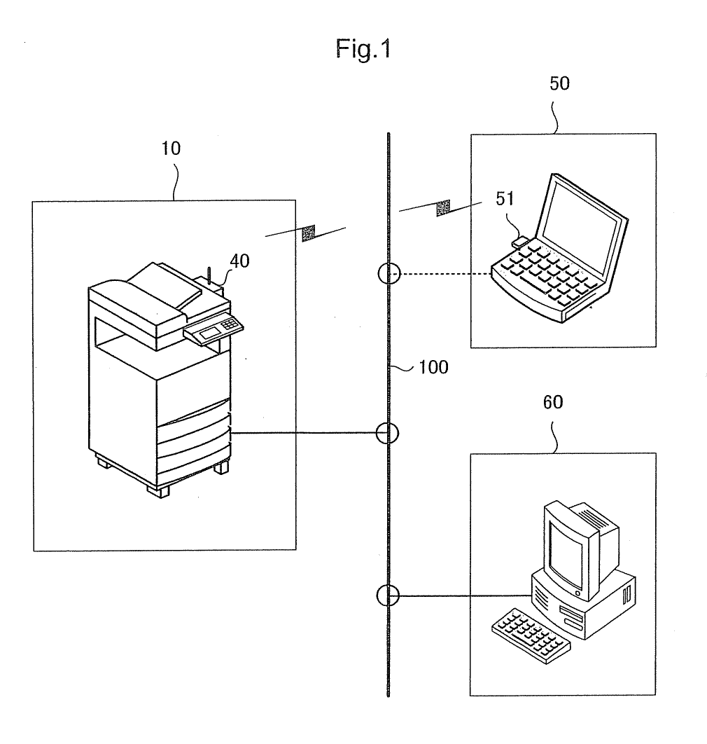

FIG. 1 is a network diagram including an image forming apparatus of the invention.

In FIG. 1, an image forming apparatus 10 is connectable to external apparatuses such as terminal apparatuses 50 and 60 via a network 100. In the following explanation, an MFP (Multi-Function Peripherals), which is a complex machine, will be explained as an example of the image forming apparatus 10. However, it is also possible to apply the invention to other image forming apparatuses such as a printer and a copying machine. As the terminal apparatuses 50 and 60, there are a PC (Personal Computer), a PDA (Personal Digital Assistant) and the like.

The MFP 10 includes a radio communication unit 40. The terminal apparatus 50 also includes a radio communication unit 51. The radio communication units 40 and 51 are capable of communicating with each other. As the radio communication units 40 and 51, for example, a Bluetooth unit is used (Bluetooth is a registered trademark).

Bluetooth is a standardized communication system that can exchange data at high speed using a radio frequency for communication among various electronic devices. A spread spectrum system of a frequency hopping type is adopted. In Bluetooth, it is possible to perform communication within a range of a radius of about 10 m. The radio communication units 40 and 51 have antennas (described later), respectively. In the following explanation, the terminal apparatus 50 including the Bluetooth unit is referred to as a radio terminal 50.

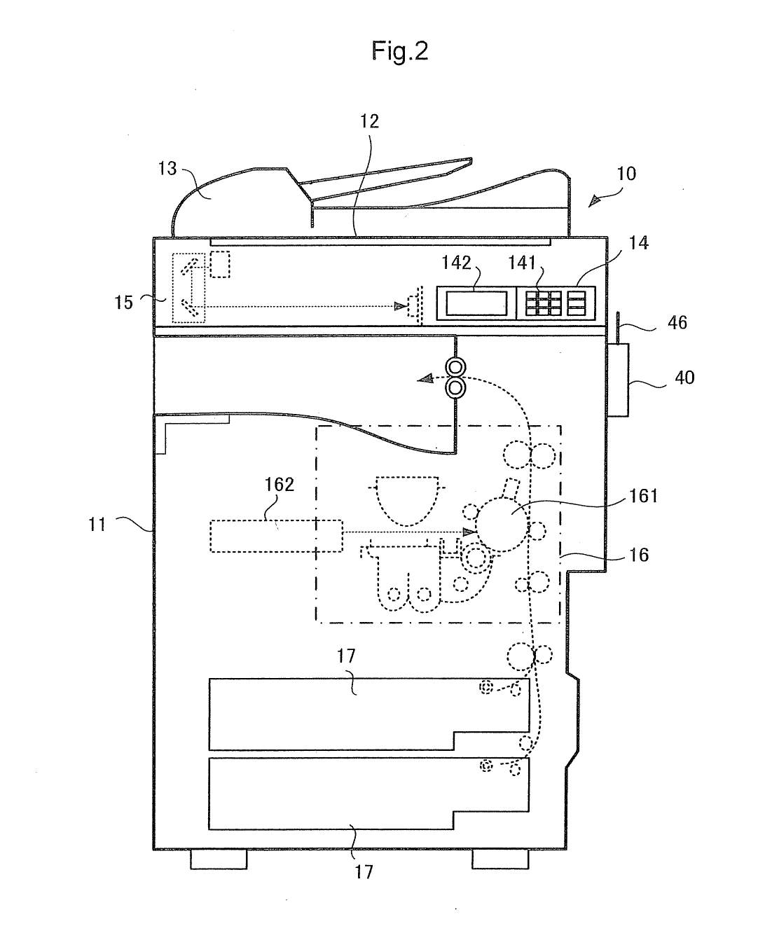

FIG. 2 is a diagram showing an example of the image forming apparatus (MFP) 10 of the invention. In FIG. 1, a document table 12 is provided in an upper part of a main body 11 of the MFP 10. An auto document feeder (ADF) 13 is provided on the document table 12 to be opened and closed freely. Moreover, an operation panel 14 is provided in the upper part of the main body 11. The operation panel 14 has an operation unit 141 including various keys and a display unit 142.

The main body 11 has a scanner 15 and a printer 16 in the inside thereof. Moreover, plural cassettes 17, in which sheets of various sizes are stored, are provided in a lower part of the main body 1. The scanner 15 scans an original fed by the ADF 13 or an original placed on the document table 12. The printer 16 includes a photoconductive drum 161 and a laser 162. The printer 16 scans and exposes the surface of the photoconductive drum 161 with a laser beam from the laser 162 to form an electrostatic latent image on the photoconductive drum 161.

A charging device, a developing device, a transfer device, and the like are arranged around the photoconductive drum 161. The electrostatic latent image on the photoconductive drum 161 is developed by the developing device and a toner image is formed on the photoconductive drum 161. The toner image is transferred onto a sheet by the transfer device. A structure of the printer 16 is not limited to the example shown in the figure. There are various systems as the structure of the printer 16.

The main body 11 includes the Bluetooth unit 40. The Bluetooth unit 40 may be built in the main body 11 or may be a type detachably mountable on the main body 11. In FIG. 2, the Bluetooth unit 40 detachably mountable on the main body 11 is shown as an example.

As functions processed by the MFP 10, there are, for example, a copy function, a printer function, a scan function, and a network print function.

The copy function is a function of monochrome or color copy. The printer function is a function of printing image data. The scan function is a function of copying image data scanned by the scanner 15. The network print function is a function of printing image data, which is sent from an external apparatus such as the radio terminal 50 or the terminal apparatus 60 to the main body 11, on the main body 11 side.

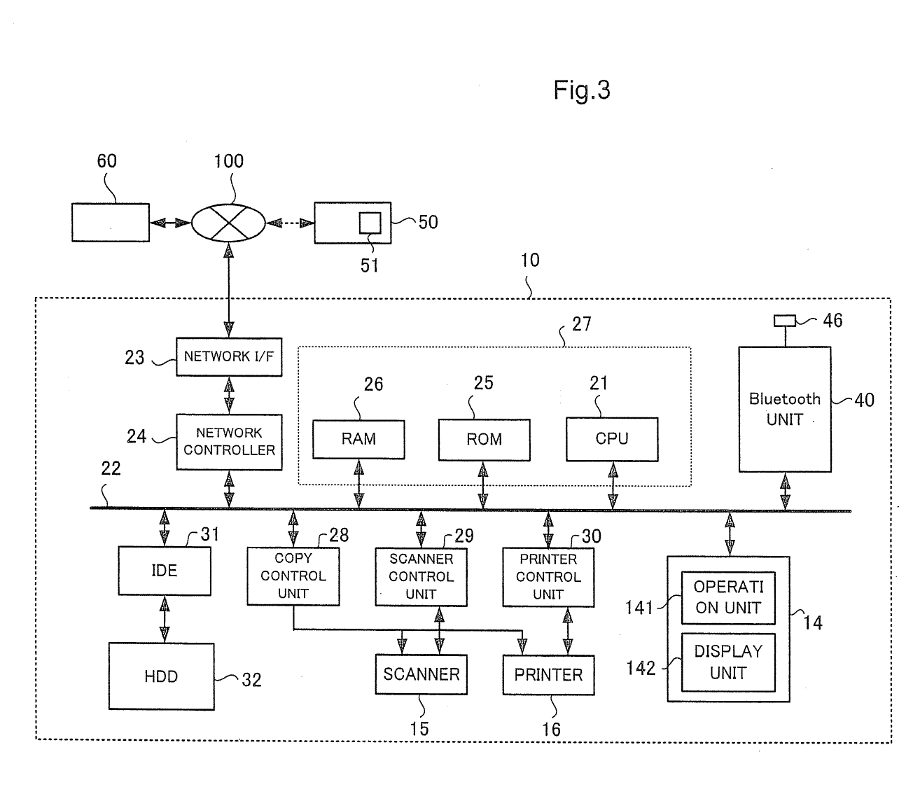

FIG. 3 is a block diagram showing a structure of the MFP 10. The MFP 10 is provided with a CPU 21. The CU 21 is connected to a PCI bus 22. The PCI bus is an abbreviation of Peripheral Component Interconnect Bus.

The MFP 10 is further provided with a network interface 23. The network interface 23 is connected to the PCI bus 22 via a network controller 24. The network interface 23 includes a LAN board and a FAX modem and is connectable to external apparatuses, for example, the radio terminal 50 and the terminal apparatus 60 via the network 100. The network controller 24 controls transmission and reception of data to and from the external apparatuses via the network interface 23.

A ROM 25 and a RAM 26 are further connected to the PCI bus 22. The ROM 25 and the RAM 26 constitute a main control unit 27 in conjunction with the CPU 21. Various control programs necessary for operations of the main body 11 are stored in the ROM 25. The RAM 26 stores various data.

A copy control unit 28, a scanner control unit 29, a printer control unit 30, and an operation panel 14 are further connected to the PCI bus 22. Moreover, an HDD 32, which is a storage device, is connected to the PCI bus 22 via an IDE 31. The IDE 31 is an interface for connecting the HDD 32 to the PCI bus 22 and is an abbreviation of Integrated Device Electronics.

The copy control unit 28 controls a normal copy function that uses the scanner 15 and the printer 16. The scanner control unit 29 controls a scan function that uses the scanner 15 and a file function for storing scanned image data in the radio terminal 50, the terminal apparatus 60, and the like. The printer control unit 30 controls a print function or a network print function that uses the printer 16. Image data in performing print processing in the printer 16 is stored in the HDD 32.

The Bluetooth unit 40 is also connected to the PCI bus 22. The CPU 21 controls the Bluetooth unit 40 to control processing for transmitting data to the radio terminal 50 and processing for receiving data transmitted from the radio terminal 50. The Bluetooth unit 51 of the radio terminal 50 has a structure same as that of the Bluetooth unit 40 and is controlled by a CPU (not shown) in the radio terminal 50.

The radio terminal 50 can make connection to the MFP 10 via the network. The radio terminal 50 and the MFP 10 can exchange data via the network 100.

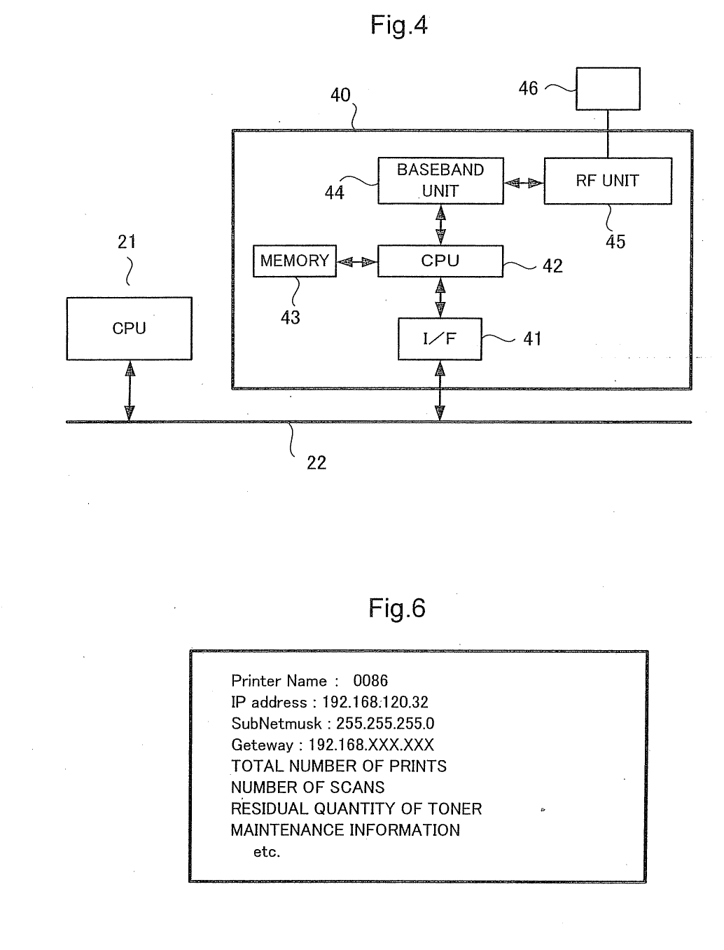

FIG. 4 is a block diagram showing the structure of the Bluetooth unit 40. The Bluetooth unit 40 has a Bluetooth interface 41, a CPU 42, a memory 43, a baseband unit 44, an RF unit 45, and an antenna 46. The Bluetooth unit 51 of the radio terminal 50 has a structure same as that in FIG. 4.

The CPU 42 controls radio communication of Bluetooth. The memory 43 stores parameters and the like set by the CPU 42. The baseband unit 44 performs data error correction and the like. The RF unit 45 performs transmission and reception of data.

Transmission data from the MFP 10 is created by the main control unit 27 under the control by the CPU 21 and sent to the baseband unit 44 via the PCI bus 22 and the Bluetooth interface 41. The base band unit 44 adds an error correcting code or the like to the transmission data, converts the transmission data into a predetermined format, and supplies the transmission data to the RF unit 45. The RF unit 45 modulates the data from the baseband unit 44 and transmits the data via the antenna 46.

A signal received through the antenna 46 is demodulated by the RF unit 45, subjected to processing such as error correction by the baseband unit 44, and sent to the PCI bus 22 via the Bluetooth interface 41.

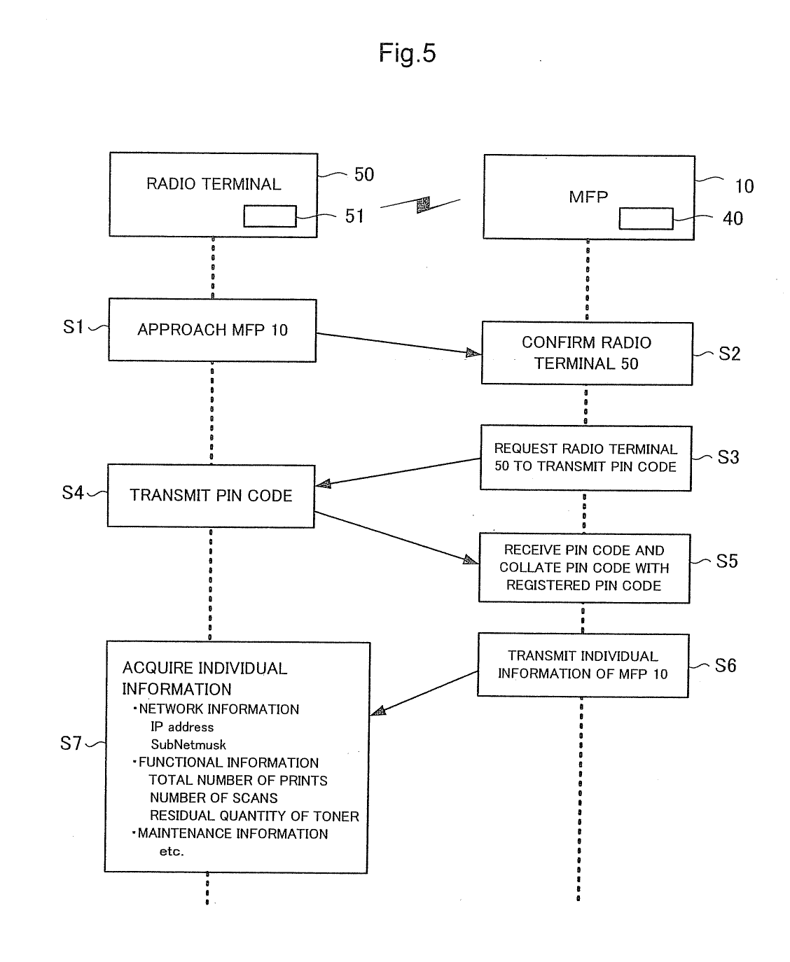

Communication processing between the MFP 10 and the radio terminal apparatus 50 will be explained with reference to a sequence chart in FIG. 5. The mutual communication is performed via the Bluetooth unit 40 and the Bluetooth unit 51.

When the Bluetooth units 40 and 51 are in operation states, respectively, the Bluetooth unit 40 of the MFP 10 performs a search to find whether the radio terminal 50 is present around the MFP 10. When the Bluetooth unit 40 receives an information signal of a hopping pattern of a predetermined frequency, this means that the radio terminal 50 is approaching the MFP 10.

First, in step S1, the user holds the radio terminal 50 and stands within a radius of 10 m from the MFP 10. In step S2, the MFP 10 confirms presence of the radio terminal 50. In the next step S3, the MFP 10 requests, for authentication, the radio terminal 50 to input a Bluetooth PIN code, which is a security code.

The PIN code is an abbreviation of Personal Identification Number. The user needs to confirm information of the PIN code with an administrator of the MFP 10 in advance. In accessing the MFP 10, in the beginning, only this PIN code is sufficient for the access.

In step S4, the user inputs the PIN code from the radio terminal 50 in accordance with the request and transmits the PIN code to the MFP 10 via the Bluetooth unit 51.

In step S5, the MFP 10 receives PIN code information transmitted from the radio terminal 50, collates the PIN code received with a PIN code registered in the CPU 21 in advance, and performs authentication for the user. When a result of the collation is correct, in step S6, the MFP 10 transmits individual information of the MFP 10 to the radio terminal 50 using an OPP (Object Push Profile).

The OPP (Object Push Profile) is an object exchange profile that defines transmission and reception of data between a server that accumulates the data (the MFP 10) and a client (the radio terminal 50). The OPP has a function of exchange of business cards.

As the individual information of the MFP 10, the MFP 10 transmits an IP address and a subnet mask, which are network information of the MFP 10. The MFP 10 also transmits information such as a total number of prints, the number of scans, and a residual quantity of toner, which is functional information of the MFP 10.

When a communication range of a network is delimited to transmit data, although a network address is set, a subnet mask is a value used in determining the network address and is calculated from an IP address.

Therefore, the radio terminal 50 can learn conditions for making connection to the network by acquiring the IP address and the subnet mask in step S7.

In this way, the user can easily acquire the information on the MFP 10. Thus, in connecting the radio terminal 50 to the network 100, the user can immediately perform setup.

FIG. 6 is a diagram showing an example of the individual information of the MFP 10 sent from the MFP 10 to the radio terminal 50. The individual information includes the IP address and the subnet mask, which are network information. Besides the network information, the individual information also includes the functional information such as the total number of prints, the number of scans, and the residual quantity of toner.

These kinds of information to be transmitted are prepared in advance by the main control unit 27 of the MFP 10 and transmitted after the PIN code is received from the radio terminal 50 and collated with the PIN code stored. It is advisable to perform setting to also transmit information useful for failure diagnosis of the MFP 10, for example, maintenance information indicating details and the like of a trouble.

After the radio terminal 50 is connected to the network 100, it is possible to print, according to the network print function, image data created by the radio terminal 50 using the MFP 10.

In Bluetooth, profiles are prepared according to application for which the profiles are used. However, a security print button may be prepared in the operation unit 141 of the control panel 14 of the MFP 10 to set a print profile to be invalid or valid. Consequently, it is possible to make the print profile valid and set printing possible for only users authenticated.

By invalidating the FTP (File Transfer Protocol), it is also possible to perform setting such that it is impossible to refer to a confidential document in the MFP 10 even if printing can be performed. Therefore, it is possible to protect security of the image forming apparatus.

As a method of using the image forming apparatus of the invention, the following cases are conceivable.

Even in the same company, management methods, rules, and the like may be different between a head office and factories. In such an environment, for example, when a meeting is held in a factory, an employee of the head office may visit the factory and use a radio terminal.

Even when the employee of the head office has a right of connection to the network but is not informed of a network environment of the factory at all, the employee is capable of checking information on setting of the network (an IP address, a subnet mask, etc.) simply by acquiring information of a Bluetooth PIN code of the image forming apparatus from a network administrator and transmitting the PIN code from the radio terminal to the image forming apparatus. Therefore, it is possible to easily perform network connection.

When a service person visits the factory and performs maintenance of the image forming apparatus, even if the service person is not informed of the network environment of the factory at all, it is possible to easily connect the radio terminal to the network by acquiring information on the Bluetooth PIN code of the image forming apparatus from the network administrator.

In this case, besides the functional information of the MFP 10, it is possible to acquire maintenance information useful for failure diagnosis, for example, details of a trouble through a web screen. This is effective in performing maintenance.

As described above, in the invention, even in an environment in which there is no DHCP (Dynamic Host Configuration Protocol) server or a new network environment, a reliable user can immediately use the image forming apparatus and the network environment simply by confirming Bluetooth PIN code information with the network administrator.

Therefore, it is possible to easily provide a user of a terminal apparatus with complicated setting contents of the network on the image forming apparatus while keeping security.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
an image forming apparatus main body that has a printer unit;
a radio communication unit that is provided in the image forming apparatus main body and is capable of performing radio communication with an external terminal apparatus; and
a control unit that controls the radio communication unit to transmit, when a transmission signal from the terminal apparatus is received by the radio communication unit, a signal for requesting a security code to the terminal apparatus and transmit, when the security code from the terminal apparatus is received, individual information including network information of the image forming apparatus to the terminal apparatus.

2. An image forming apparatus according to claim 1, wherein the control unit controls the radio communication unit to transmit an IP address and a subnet mask of the image forming apparatus to the terminal apparatus as the network information.

3. An image forming apparatus according to claim 1, wherein the control unit controls the radio communication unit to transmit functional information and maintenance information of the image forming apparatus to the terminal apparatus as the individual information.

4. An image forming apparatus according to claim 1, wherein the radio communication unit is a Bluetooth unit.

5. An image forming apparatus according to claim 4, wherein the control unit requests the terminal apparatus to transmit a PIN code (Personal Identification Number code) as the security code and receives the PIN code transmitted from the terminal apparatus to perform user authentication.

6. An image forming apparatus according to claim 4, wherein the control unit transmits the individual information to the terminal apparatus subjected to the user authentication using an OPP (Object Push Profile).

7. An image forming apparatus according to claim 4, wherein the control unit permits the terminal apparatus subjected to the user authentication a print profile but does not permit the terminal apparatus a file transfer profile.

8. An image forming apparatus according to claim 1, wherein
the terminal apparatus is connectable to the image forming apparatus via a network, and
the terminal apparatus receives, with radio communication, the network information transmitted from the image forming apparatus and performs setting for the network connection using the network information received.

9. A control method of an image forming apparatus, the image forming apparatus including a Bluetooth unit that is capable of performing radio communication with an external terminal apparatus,
the control method comprising:
controlling the radio communication unit to transmit a signal for requesting a PIN code (Personal Identification Number code) to the terminal apparatus, when a transmission signal from the terminal apparatus is received by the radio communication unit; and
controlling the radio communication unit to transmit individual information including a network information of the image forming apparatus to the terminal apparatus, when the PIN code is received from the terminal apparatus.

10. A control method of an image forming apparatus according to claim 9, wherein the radio communication unit is controlled to transmit an IP address and a subnet mask of the image forming apparatus to the terminal apparatus as the network information.

11. A control method of an image forming apparatus according to claim 9, wherein the radio communication unit is controlled to transmit functional information and maintenance information of the image forming apparatus to the terminal apparatus as the individual information.

12. A control method of an image forming apparatus according to claim 9, wherein the terminal apparatus is requested to transmit the PIN code and, when the PIN code is transmitted from the terminal apparatus, the PIN code is received to perform user authentication.

13. A control method of an image forming apparatus according to claim 9, wherein the individual information is transmitted to the terminal apparatus subjected to the user authentication using an OPP (Object Push Profile).

14. A control method of an image forming apparatus according to claim 9, wherein the terminal apparatus subjected to the user authentication is permitted a print profile but is not permitted a file transfer profile.

15. A network system comprising:
an image forming apparatus having a first Bluetooth unit that is capable of performing radio communication with a terminal apparatus; and
the terminal apparatus that is connectable to the image forming apparatus via a network and having a second Bluetooth unit that is capable of performing radio communication with the image forming apparatus, wherein
the image forming apparatus and the terminal apparatus perform radio communication using the first and the second Bluetooth units,
the image forming apparatus transmits, when a transmission signal is received from the terminal apparatus, a signal for requesting a PIN code (Personal Identification Number code) to the terminal apparatus and transmits, when the PIN code is received from the terminal apparatus, individual information including network information of the image forming apparatus to the terminal apparatus, and
the terminal apparatus receives the network information transmitted from the image forming apparatus and makes it possible to perform setting for making connection to the network using the network information received.

16. A network system according to claim 15, wherein the image forming apparatus transmits an IP address and a subnet mask of the image forming apparatus to the terminal apparatus as the network information.

17. A network system according to claim 15, wherein the image forming apparatus transmits functional information and maintenance information of the image forming apparatus to the terminal apparatus as the individual information.

18. A network system according to claim 15, wherein the image forming apparatus receives the PIN code transmitted from the terminal apparatus to perform user authentication and transmits the individual information to the terminal apparatus subjected to the user authentication using an OPP (Object Push Profile).

19. A network system according to claim 18, wherein the image forming apparatus permits the terminal apparatus subjected to the user authentication a print profile but does not permit the terminal apparatus a file transfer profile.
